(19) United States
(12) Patent Application Publication
(10) Pub. No.: US 2020/0086974 A1
(43) Pub. Date: Mar. 19, 2020

(54) HIGH-LIFT DEVICE AND AIRCRAFT WING

(71) Applicant: MITSUBISHI HEAVY INDUSTRIES, LTD., Tokyo (JP)

(72) Inventor: Shinsuke NISHIMURA, Tokyo (JP)

(21) Appl. No.: 16/617,197

(22) PCT Filed: Feb. 28, 2019
(86) PCT No.: PCT/JP2019/007807

§ 371 Date: Nov. 26, 2019

(30) Foreign Application Priority Data
Mar. 7, 2018 (JP) 2018-041232

(51) Int. Cl. B64C 9/24; B64C 13/00

(52) U.S. Cl. CPC B64C 9/24; B64C 13/00

(57) ABSTRACT

A high-lift device to be provided on a main wing body of an aircraft includes a slat and a slat moving mechanism moving the slat between a deployed position and a retracted position. The slat includes a slat front surface, a slat rear surface, and a fillet surface between the slat front surface and the slat rear surface, the slat rear surface is a curved surface recessed toward inside of the slat, the fillet surface is a curved surface projecting outward the slat, and, in a cross section taken along a plane orthogonal to a pitch axis direction of the aircraft, an inflection point between the slat rear surface and the fillet surface is positioned lower than a vertex on a front side of the main wing body when the slat is retracted.

### FIELD

The present invention relates to a high-lift device including a slat, and an aircraft wing.

### BACKGROUND

In prior art, there is a known method for reducing aircraft noise. The method includes: deploying an elongated thin plate (slat) from a fixed leading edge of an aircraft wing; and separately deploying an upper bridging element by sliding the upper bridging element to brides a gap between the thin plate and the upper surface of fixed leading edge, thereby making the upper surface of the aircraft wing serve as a continuous aerodynamic surface (for example, see Patent Literature 1).

### CITATION LIST

### Patent Literature

Patent Literature 1: U.S. Pat. No. 8,864,083

### SUMMARY

### Technical Problem

Generally, a slat provided in a high-lift device has a surface (rear surface) on the rear side formed in a shape complementary to a surface (front surface) on the front side of a main wing to prevent interference with the main wing when the slat is retracted. In addition, the slat is formed to have a surface continuing to an upper surface and a lower surface of the main wing. By contrast, the slat of Patent Literature 1 has a shape to reduce noise of the aircraft. For this reason, in a cross section taken along a plane orthogonal to the pitch axis, the rear surface of the slat has no shape complementary to the front surface of the main wing, and interferes with the main wing when the slat is retracted. For this reason, the slat of Patent Literature 1 requires major changes in design from ordinary slats.

The present invention has an object to provide a high-lift device and an aircraft wing, without performing major design changes on the slat, enabling suppression of physical interference of the slat with the main wing body and reduction in noise.

### Solution to Problem

According to the present invention, a high-lift device to be provided on a main wing body of an aircraft includes: a slat that is provided on a front side of the main wing body; and a slat moving mechanism that moves the slat between a deployed position in which the slat is deployed forward and a retracted position in which the slat is retracted rearward. The slat includes: a slat front surface that is a surface on a front side of the slat; a slat rear surface that faces a front of the main wing body and is a surface on a rear side of the slat; and a fillet surface that is formed, on a lower surface side of the main wing body, to extend between the slat front surface and the slat rear surface, and is a surface continuing to each of the slat front surface and the slat rear surface. The slat rear surface is a curved surface recessed toward inside of the slat and having a shape complementary to the main wing body. The fillet surface is a curved surface that projects outward the slat. In a cross section obtained by cutting the slat with a plane orthogonal to a pitch axis direction of the aircraft, an inflection point between the slat rear surface and the fillet surface is positioned lower than a vertex on the front side of the main wing body in a yaw axis direction of the aircraft when the slat is retracted.

With this structure, the slat includes the filet surface, so that the air current flowing from the slat front surface to the slat rear surface via the fillet surface is prevented from being separated from the slat. This suppresses formation of turbulence caused by separation of the air current flowing to the slat rear surface, and reduces noise of the aircraft due to change in pressure of turbulence. In this state, the inflection point between the slat rear surface and the fillet surface is positioned lower than the front vertex of the main wing body in the yaw axis direction of the aircraft. This structure enables treating of the fillet surface as a surface obtained by cutting off part of the ordinary slat. Because the slat can be formed in a shape obtained by cutting a corner portion of an ordinary slat, this structure removes necessity for great change in design. In addition, because the slat rear surface is a curved surface having a shape complementary to the main wing body, this structure suppresses physical interference with the main wing body when the slat is retracted.

It is preferable that, in the cross section obtained by cutting the slat with a plane orthogonal to the pitch axis direction of the aircraft, where R1 is an average radius of curvature obtained by averaging radiuses of curvature over the fillet surface, and R2 is an average radius of curvature obtained by averaging radiuses of curvature over the slat rear surface, the average radius of curvature R1 is smaller than the average radius of curvature R2.

This structure reduces the region in which the fillet surface is formed to a size smaller than the region in which the slat rear surface is formed. This enables a shape with high noise reduction effect, while design change of the slat remains minor.

It is preferable that, in the cross section obtained by cutting the slat with a plane orthogonal to the pitch axis direction of the aircraft, where a vertex P1 is a vertex on the front side of the main wing body in a roll axis direction of the aircraft, an inflection point P2 is an inflection point between the slat rear surface and the fillet surface when the slat is retracted, a point p100 is a point on the rear side of the slat at which the slat front surface crosses the slat rear surface, a point p101 is a point at which a straight line connecting the point p100 with the inflection point P2 crosses the slat front surface, a point p102 is a point on the slat front surface located in the same position as that of the vertex P1 in the yaw axis direction of the aircraft, a point p103 is a point at which a straight line connecting the point p100 with the point p102 crosses the slat rear surface, a length L1 is a length of a straight line connecting the point p101 with the point P2, and a length Lref1 is a length of a straight line connecting the point p102 with the point p103, the length L1 and the length Lref1 satisfy a relation of L1≤Lref1.

This structure enables the slat to have an optimum shape, and more reduces noise. When the length L1 is 0, the shape is the same as the conventional shape, and the length L1 exhibiting the effect of reducing noise is approximately 0.1Lref1≤L1. For this reason, the length L1 and the length Lref1 more preferably fall within the range of 0.1Lref1≤L1≤Lref1. In addition, when the length L1 becomes longer with respect to the length Lref1, a gap between the slat and the main wing body formed in retracting becomes wide. For this reason, to prevent the gap from being too wide, the relation of L1≤0.5Lref1 is preferably satisfied, and the length L1 and the length Lref1 more preferably fall within the range of 0.1Lref1≤L1≤0.5Lref1.

It is preferable that the high-lift device further includes: a closing member that is provided on the lower surface side of the main wing body and closes a gap between the slat retracted in the retracted position and the main wing body; and a closing member moving mechanism that moves the closing member between a closed position in which the closing member closes the gap when the slat is retracted and a received position in which the closing member is received when the slat is deployed.

This structure enables the slat and the lower surface of the main wing body to serve as a continuous surface by closing, with the closing member, the gap between the slat and the main wing body formed in retracting. This structure suppresses resistance on the wing lower surface when the aircraft is in flight.

According to the present invention, an aircraft wing includes a main wing body and the above-described high-lift device provided on the main wing body.

This structure reduces noise generated with the wing of the aircraft.

### BRIEF DESCRIPTION OF DRAWINGS

FIG. 1 is a schematic diagram illustrating a main wing and therearound of an aircraft during takeoff and landing according to the embodiment.

FIG. 2 is a schematic diagram illustrating the main wing and therearound of the aircraft during flight according to the embodiment.

FIG. 3 is a schematic diagram of a slat of a high-lift device according to the embodiment.

FIG. 4 is a diagram illustrating a noise level generated with a slat of a conventional high-lift device.

FIG. 5 is a diagram illustrating a noise level generated with the slat of the high-lift device according to the embodiment.

### DESCRIPTION OF EMBODIMENTS

An embodiment according to the present invention will be described in detail with reference to the drawings. The present invention is not limited to the embodiment. Constituent elements in the following embodiment include ones that can replace the elements and are easy for the skilled person, or substantially the same ones. The constituent elements described hereinafter can properly be used in combination. In addition, when there are a plurality of embodiments, the embodiments may be combined with each other.

### Embodiment

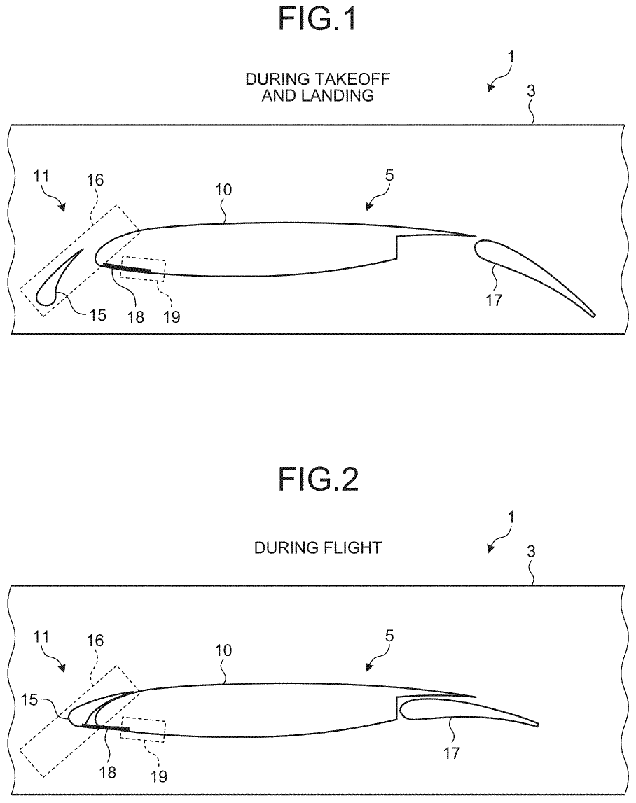

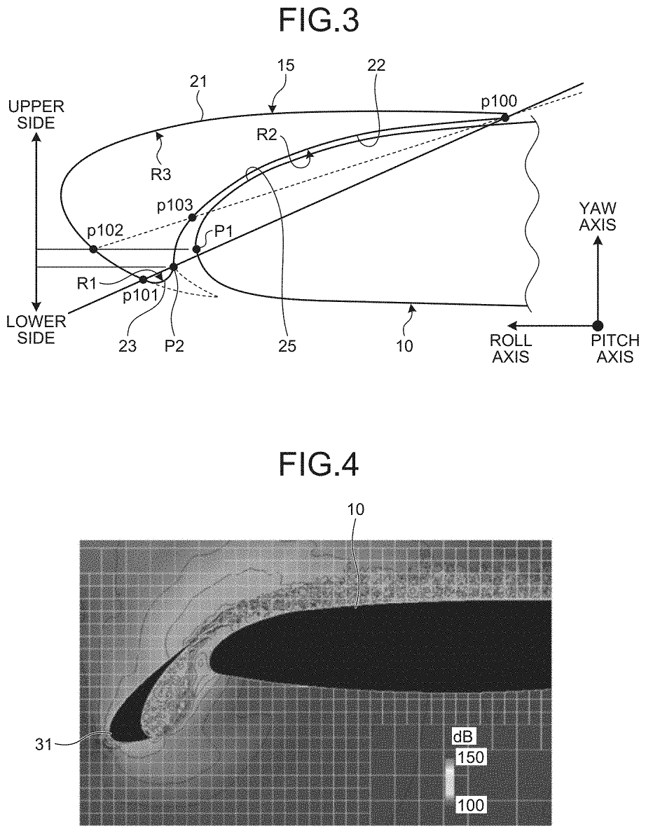

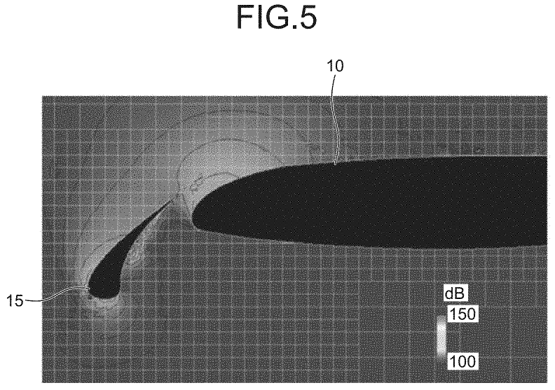

A high-lift device 11 according to the present invention is a device to be provided on a wing of an aircraft 1, to generate lift at low speed for takeoff or landing. The high-lift device 11 is provided on a main wing 5, which is a wing of the aircraft 1. FIG. 1 is a schematic diagram illustrating the main wing and therearound of the aircraft during takeoff and landing according to the present embodiment. FIG. 2 is a schematic diagram illustrating the main wing and therearound of the aircraft during flight according to the present embodiment. FIG. 3 is a schematic diagram of a slat of a high-lift device according to the present embodiment. FIG. 4 is a diagram illustrating a noise level generated with a slat of a conventional high-lift device. FIG. 5 is a diagram illustrating a noise level generated with the slat of the high-lift device according to the present embodiment.

First, the following is an explanation of the aircraft 1. The aircraft 1 includes a fuselage 3, the main wing 5, a horizontal tail, and a vertical tail. The fuselage 3 is a cylindrical member provided to extend in a roll axis direction serving as a direction connecting the nose and the tail of the aircraft 1. The main wing 5 is provided in the vicinity of the center portion of the fuselage 3, and serves as a wing member extending outward the fuselage 3 in a pitch axis direction orthogonal to the roll axis direction. Although illustration is omitted, the horizontal tail is provided on the tail side of the fuselage 3 and serves as a wing member extending outward the fuselage 3 in the pitch axis direction, and the vertical tail is provided on the tail side of the fuselage 3 and serves as a wing member extending outward the fuselage 3 in a yaw axis direction orthogonal to the roll axis direction and the pitch axis direction.

As illustrated in FIG. 1 and FIG. 2, the main wing 5 includes a main wing body 10 and the high-lift device 11. The main wing body 10 is a structure mainly forming the main wing 5. The main wing body 10 is formed in a wing shape in a cross section taken along a plane orthogonal to the pitch axis direction. A wing external surface of the main wing body 10 includes a wing upper surface on the upper side in the yaw axis direction, a wing lower surface on the lower side in the yaw axis direction, and a wing front surface 25 (see FIG. 3) on the front side in the roll axis direction.

The high-lift device 11 is a device increasing lift of the main wing 5 to suppress a stall of the aircraft 1 when the aircraft 1 is at low speed during takeoff or landing of the aircraft 1. The high-lift device 11 includes a slat device provided on the front side of the main wing body 10 and a flap device provided on the rear side of the main wing body 10. Specifically, the high-lift device 11 includes a slat 15, a slat moving mechanism 16, a flap 17, a closing member 18, and a closing member moving mechanism 19.

The slat 15 forms a leading edge of the main wing 5, and provided on the front side of the main wing body 10. The slat 15 is provided to extend in the pitch axis direction. As illustrated in FIG. 3, in a cross section taken along a plane orthogonal to the pitch axis direction, an external surface of the slat 15 includes a slat front surface 21 on the front side in the roll axis direction, a slat rear surface 22 on the rear side in the roll axis direction, and a fillet surface 23 located on the wing lower surface side and between the slat front surface and the slat rear surface. The detailed shape of the slat 15 will be described later.

The slat moving mechanism 16 moves the slat 15 between a deployed position in the front and a retracted position in the rear. The deployed position serves as a position in which the slat 15 is deployed forward during takeoff and landing (at low speed) of the aircraft 1. The retracted position serves as a position in which the slat 15 is retracted rearward during flight (at high speed) of the aircraft 1. For this reason, the slat moving mechanism 16 moves the slat 15 to the deployed position during takeoff and landing of the aircraft 1, and moves the slat 15 to the retracted position during flight of the aircraft 1. The slat 15 moved to the deployed position forms a gap between the main wing body 10 and the slat 15. For this reason, part of an air current hitting on the slat 15 flows from the slat front surface 21 toward the wing upper surface of the main wing body 10. Part of the rest of the air current hitting on the slat 15 flows from the slat front surface 21 along the slat rear surface 22 via the fillet surface 23, and flows between the slat 15 and the main wing body 10. In addition, part of the rest of the air current hitting on the slat 15 flows from the slat front surface 21 toward the wing lower surface of the main wing body 10. The slat 15 moved to the retracted position is received on the wing front surface 25 of the main wing body 10, whereby the slat front surface 21 and the wing upper surface of the main wing body 10 form a continuous surface.

The following is an explanation of the shape of the slat 15 in a cross section taken along a plane orthogonal to the pitch axis direction, with reference to FIG. 3. As illustrated with a broken line of FIG. 3, a conventional ordinary slat has a shape in which a region on the wing lower surface side serves as a corner formed by the slat front surface 21 and the slat rear surface 22. In the case of such a shape, separation of the air current flowing from the slat front surface 21 along the slat rear surface 22 via the corner portion occurs at the corner. This causes, on the slat rear surface 22, turbulence due to the separation of the air current, and causes noise due to change in pressure caused by the turbulence. For this reason, in the present embodiment, the fillet surface 23 described above is formed on the wing lower surface side of the slat 15. As illustrated in FIG. 3, the fillet surface 23 is a surface obtained by cutting off the corner portion of a conventional slat.

The slat front surface 21 is a curved surface curved in a bow shape projecting outward in the forward direction of the slat 15. The upper surface of the slat front surface 21 serves as a surface connecting to the wing upper surface of the main wing body 10, when the slat 15 is retracted. The lower surface of the slat front surface 21 serves as a surface separated, with a gap, from the wing lower surface of the main wing body 10, when the slat 15 is retracted.

The slat rear surface 22 is a curved surface curved in a bow shape recessed inward the slat 15 in the forward direction. The slat rear surface 22 serves as a surface facing the wing front surface 25 of the main wing body 10, and is a curved surface having a shape complementary to the wing front surface 25 of the main wing body 10. For this reason, the slat rear surface 22 serves as a surface enabling avoidance of physical interference with the wing front surface 25 of the main wing body 10, when the slat 15 is retracted. The slat front surface 21 and the slat rear surface 22 form a discontinuous surface on the upper side in the yaw axis direction of the slat 15, and form a corner portion with an acute angle.

The fillet surface 23 serves as a surface connecting to the slat front surface 21 and the slat rear surface 22 on the lower side in the yaw axis direction of the slat 15, and is a curved surface curved in a bow shape projecting outward the slat 15 in the backward direction. The fillet surface 23 serves as a surface separated, with a gap, from the wing front surface and the wing lower surface of the main wing body 10, when the slat 15 is retracted.

The boundary between the slat front surface 21 and the fillet surface 23 serves as the lowest point in the yaw axis direction, and the boundary between the fillet surface 23 and the slat rear surface 22 is an inflection point P2. Specifically, the fillet surface 23 serves as a surface between the lowest point and the inflection point P2, in a cross section taken along a surface orthogonal to the pitch axis direction.

The inflection point P2 is a point at which a curve of the curved surface changes from the direction in which the fillet surface 23 is curved to project outward the slat 15 to the direction in which the slat rear surface 22 is curved to be recessed inward the slat 15. Where P1 is a vertex on the front side of the main wing body 10, that is, the forefront point of the main wing body 10 in the roll axis direction, the inflection point P2 is positioned on the side lower than the vertex P1 in the yaw direction. In addition, the inflection point P2 is positioned in front of the vertex P1 in the roll axis direction.

In the cross section taken along a plane orthogonal to the pitch axis direction, suppose that R1 is an average radius of curvature obtained by averaging the radiuses of curvature of the fillet surface 23 over the whole surface. In the same manner, suppose that R2 is an average radius of curvature obtained by averaging the radiuses of curvature of the slat rear surface 22 over the whole surface, and R3 is an average radius of curvature obtained by averaging the radiuses of curvature of the slat front surface 21 over the whole surface. In this case, the average radius of curvature R2 of the slat rear surface 22 is smaller than the average radius of curvature R3 of the slat front surface 21, and the average radius of curvature R1 of the fillet surface 23 is smaller than the average radius of curvature R2 of the slat rear surface 22. In short, the slat front surface 21, the slat rear surface 22, and the fillet surface 23 satisfy the relation of R1<R2<R3.

The following is an explanation of the shape of the slat 15 when the average radius of curvature R1 and the average radius of curvature R2 are replaced with line segments. Suppose that length L1 is a length of the line segment replacing the average radius of curvature R1, and length L2 is a length of the line segment replacing the average radius of curvature R2. As illustrated in FIG. 4, in a cross-section taken along a plane orthogonal to the pitch axis direction, suppose that a point p100 is a point at which the slat front surface 21 crosses the slat rear surface 22 on the rear side of the slat 15, and a point p101 is a point at which a straight line (solid line) connecting the point p100 with the inflection point P2 crosses the slat front surface 21. In addition, suppose that a point p102 is a point of the slat front surface 21 located in the same position as that of the vertex P1, and a point p103 is a point at which a straight line (dotted line) connecting the point p100 with the point p102 crosses the slat rear surface 22. In this state, the length L1 described above is a length of a straight line connecting the point p101 with the point P2, and the length L2 described above is a length of a straight line connecting the point p100 with the point P2. In addition, suppose that length Lref1 is a length of a straight line connecting the point p102 with the point p103, and length Lref2 is a length of the straight line connecting the point p100 with the point p103. In this case, the slat 15 has a shape in which the length L1 and the length Lref1 satisfy the relation of L1≤Lref1.

When the length L1 is 0, the shape is the same as the conventional shape (dotted line), and the length L1 exhibiting the effect of reducing noise is approximately 0.1Lref1≤L1. For this reason, the length L1 and the length Lref1 more preferably fall within the range of 0.1Lref1≤L1≤Lref1. In addition, when the length L1 becomes longer with respect to the length Lref1, a gap between the slat 15 and the main wing body 10 formed in retracting becomes wide. For this reason, to prevent the gap from being too wide, the relation of L1≤0.5Lref1 is preferably satisfied, and the length L1 and the length Lref1 more preferably fall within the range of 0.1Lref1 L1≤0.5Lref1. When the length L1 is determined, the length L2 corresponding to the length L1 is determined.

As illustrated in FIG. 1 and FIG. 2, the closing member 18 is provided on the wing lower surface side of the main wing body 10, to close the gap between the slat 15 retracted in the retracted position and the main wing body 10. The closing member 18 is provided to extend in the pitch axis direction, and formed in a thin plate shape. The closing member 18 closes the gap between the slat 15 and the main wing body 10, to form a surface between the slat 15 and the main wing body 10 such that the slat front surface 21 of the slat 15 and the wing lower surface of the main wing body 10 form a continuous surface.

The closing member moving mechanism 19 moves the closing member 18 between a front closed position and a rear received position. The closed position serves as a position in which the closing member 18 is deployed forward when the aircraft 1 is in flight (at high speed), that is, when the slat 15 is retracted. The received position serves as a position in which the closing member 18 is received rearward when the aircraft 1 takes off or lands (at low speed), that is, when the slat 15 is deployed. For this reason, the closing member moving mechanism 19 moves the closing member 18 to the received position when the aircraft 1 takes off or lands, while the closing member moving mechanism 19 moves the closing member 18 to the closed position when the aircraft 1 is in flight. Because the closing member 18 having been moved to the received position opens the gap between the slat 15 and the main wing body 10, the closing member 18 does not obstruct generation of lift during takeoff and landing of the aircraft 1. Because the closing member 18 having been moved to the closed position closes the gap between the slat 15 and the main wing body 10, this structure reduces air resistance to the main wing 5 due to the gap between the slat 15 and the main wing body 10, when the aircraft 1 is in flight.

In the following, noise generated with a conventional slat 31 and noise generated with the slat 15 of the present embodiment are compared with reference to FIG. 4 and FIG. 5. FIG. 4 is a diagram of a volume level generated with the conventional slat 31, and FIG. 5 is a diagram of a volume level generated with the slat 15 according to the present embodiment. As illustrated in FIG. 4, turbulence occurs on the rear side of the slat rear surface of the slat 31, and the turbulence continues to the wing upper surface of the main wing body 10 through the gap between the slat 31 and the main wing body 10. A noise region having a certain volume level is widely formed on an upper side of the gap between the slat 31 and the main wing body 10. By contrast, as illustrated in FIG. 5, less turbulence occurs in comparison with the conventional art on the rear side of the slat rear surface 22 of the slat 15, and less turbulence occurs in comparison with the conventional art also in the wing upper surface of the main wing body 10. For this reason, a noise region formed in the wing upper surface of the main wing body 10 is smaller than that in the conventional art.

As described above, according to the present embodiment, the fillet surface 23 is formed in the slat 15. This structure prevents the air current flowing from the slat front surface 21 to the slat rear surface 22 via the fillet surface 23 from being separated from the slat 15. This structure suppresses formation of turbulence caused by separation of the air current, and reduces noise of the aircraft 1 caused by change in pressure of turbulence. In this state, the inflection point P2 between the slat rear surface 22 and the fillet surface 23 is positioned lower than the front vertex P1 of the main wing body 10 in the yaw axis direction. This structure enables treating of the fillet surface 23 as a surface obtained by cutting off part of the ordinary slat 15. Because the slat can therefore be formed in a shape obtained by cutting a corner portion of the conventional ordinary slat 31, this structure removes necessity for great change in design of the slat 15. In addition, because the slat rear surface 22 is a curved surface having a shape complementary to the main wing body 10, this structure suppresses physical interference with the main wing body 10 when the slat 15 is retracted.

In addition, according to the present embodiment, the average radius of curvature R1 is set smaller than the average radius of curvature R2. This structure reduces the region in which the fillet surface 23 is formed to a size smaller than the region in which the slat rear surface 22 is formed. This structure enables the slat 15 to have a shape with high noise reduction effect, while change in design of the slat 15 is set slight.

In addition, according to the present embodiment, the length L1 and the length Lref1 satisfy the relation of L1 Lref1. This structure enables the slat 15 to have a more optimum shape, and more reduces noise.

In addition, according to the present embodiment, the closing member 18 is moved to the closed position. This structure suppresses air resistance on the wing lower surface when the aircraft 1 is in flight.

### REFERENCE SIGNS LIST

1 AIRCRAFT
3 FUSELAGE
5 MAIN WING
10 MAIN WING BODY
11 HIGH-LIFT DEVICE
15 SLAT
16 SLAT MOVING MECHANISM
17 FLAP
18 CLOSING MEMBER
19 CLOSING MEMBER MOVING MECHANISM
21 SLAT FRONT SURFACE
22 SLAT REAR SURFACE
23 FILLET SURFACE
25 WING FRONT SURFACE
31 SLAT (CONVENTIONAL)

1. A high-lift device to be provided on a main wing body of an aircraft, comprising:
a slat that is provided on a front side of the main wing body; and
a slat moving mechanism that moves the slat between a deployed position in which the slat is deployed forward and a retracted position in which the slat is retracted rearward, wherein
the slat includes:
a slat front surface that is a surface on a front side of the slat;
a slat rear surface that faces a front of the main wing body and is a surface on a rear side of the slat; and
a fillet surface that is formed, on a lower surface side of the main wing body, to extend between the slat front surface and the slat rear surface, and is a surface continuing to each of the slat front surface and the slat rear surface,
the slat rear surface is a curved surface recessed toward inside of the slat and having a shape complementary to the main wing body,
the fillet surface is a curved surface that projects outward the slat, and
in a cross section obtained by cutting the slat with a plane orthogonal to a pitch axis direction of the aircraft, an inflection point between the slat rear surface and the fillet surface is positioned lower than a vertex on the front side of the main wing body in a yaw axis direction of the aircraft when the slat is retracted.

2. The high-lift device according to claim 1, wherein
in the cross section obtained by cutting the slat with a plane orthogonal to the pitch axis direction of the aircraft, where R1 is an average radius of curvature obtained by averaging radiuses of curvature over the fillet surface, and R2 is an average radius of curvature obtained by averaging radiuses of curvature over the slat rear surface,
the average radius of curvature R1 is smaller than the average radius of curvature R2.

3. The high-lift device according to claim 1, wherein
in the cross section obtained by cutting the slat with a plane orthogonal to the pitch axis direction of the aircraft,
where
a vertex P1 is a vertex on the front side of the main wing body in a roll axis direction of the aircraft,
an inflection point P2 is an inflection point between the slat rear surface and the fillet surface when the slat is retracted,
a point p100 is a point on the rear side of the slat at which the slat front surface crosses the slat rear surface,
a point p101 is a point at which a straight line connecting the point p100 with the inflection point P2 crosses the slat front surface,
a point p102 is a point on the slat front surface located in the same position as that of the vertex P1 in the yaw axis direction of the aircraft,
a point p103 is a point at which a straight line connecting the point p100 with the point p102 crosses the slat rear surface,
a length L1 is a length of a straight line connecting the point p101 with the point P2, and
a length Lref1 is a length of a straight line connecting the point p102 with the point p103,
the length L1 and the length Lref1 satisfy a relation of L1≤Lref1.

4. The high-lift device according to claim 1, further comprising:
a closing member that is provided on the lower surface side of the main wing body and closes a gap between the slat retracted in the retracted position and the main wing body; and
a closing member moving mechanism that moves the closing member between a closed position in which the closing member closes the gap when the slat is retracted and a received position in which the closing member is received when the slat is deployed.

5. An aircraft wing comprising:
a main wing body; and
the high-lift device according to claim 1 provided on the main wing body.
